(19) United States
(12) Patent Application Publication
(10) Pub. No.: US 2003/0164336 A1
(43) Pub. Date: Sep. 4, 2003

(54) Processes of reducing contamination from cellulosic suspensions

(76) Inventors: Josephine Michelle Weir, West Yorkshire (GB); Mark Anthony Laycock, West Yorkshire (GB)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/332,968

(22) PCT Filed: Jul. 13, 2001
(86) PCT No.: PCT/EP01/08115

(30) Foreign Application Priority Data
Jul. 27, 2000 (GB) 0018314.5

(51) Int. Cl. C02F 1/24

(52) U.S. Cl. 210/705

(57) ABSTRACT

A method of removing synthetic hydrophobic resinous particles from a waste treatment process in which an aqueous cellulosic suspension is formed from waste cellulosic material in a pulping stage, passing the cellulosic suspension to a separation stage in which particles of ink and/or synthetic hydrophobic resinuous materials are separated from the cellulosic suspension, and optionally subjecting the cellulosic suspension to a washing stage and/or thickening stage to provide a treated pulp, in which process water from the separation stage and/or washing and/or thickening stages is clarified in a clarification stage in which suspended solids, comprising synthetic hydrophobic resinous particles are removed, and the clarified water is fed to the pulping stage in a clarification loop and/or combined with the treated pulp, wherein a water soluble cationic polymer is added to the process water at or prior to the clarification stage, characterised in that the water soluble cationic polymer formed from a monomer blend comprising, a first water soluble cationic monoment selected from the group consisting of diallyl dialkyl ammonium halide, dialkylaminoalkyl (meth)acrylamide and dialkylaminoalkyl (meth)acrylate, including quaternary ammonium salts and acid addition salts thereof, and a second water soluble cationic monomer comprising a hydrophobic moiety.

The present invention relates to the minimisation of hydrophobic synthetic resinous particles and problems associated with cellulosic suspensions produced from processes for recycling waste cellulosic material, such as deinking processes and novel cationic polymeric materials, which may be used in said processes.

It is well known that reprocessed pulps produced from deinking processes and other waste paper reprocessing processes tend to become contaminated with colloidal hydrophobic synthetic material which has a tendency to aggregate and be deposited as sticky residues. These residues may be deposited on apparatus utilised for handling the waste paper and/or on paper making machinery utilising the reprocessed pulp.

The synthetic resinous particles are often referred to as “stickies” but should they should not be confused with natural resinous materials such as pitch. These synthetic particles tend to originate from the reprocessing of waste paper that contains synthetic polymeric coatings, such as gloss paper coatings. Typically reprocessing waste paper which comprises magazine grade paper can result in the formation these sticky particles.

The presence of synthetic hydrophobic resinous particles can present serious operational problems to the paper maker when deinked paper pulp containing stickies is used in paper manufacture. The particles tend to agglomerate and deposit on the machinery as sticky deposits this can seriously affect the paper making operation. Sticky deposits on for instance the paper machine rollers, felts or other components that are in direct contact with the formed paper sheet can impair the quality of the paper that is formed. Deposits can even cause breaks and tears in the paper sheet, which will normally mean that the paper machine has to be stopped and cleaned. In certain cases sticky deposits can actually damage the paper machine components, such as the felts.

Various treatments are known for minimising contamination from stickies. For instance it is known to treat a thick stock with bentonite for this purpose. Bentonite is a naturally occurring material of variable quality. It would be desirable to be able to achieve reduction of stickies contamination using synthetic material of controllable quality. It will also be desirable to obtain better results than are obtainable using bentonite.

It is also known to use various polymers. Examples are low molecular weight coagulants and the polymers mentioned in U.S. Pat. Nos.5,433,824, 5,368,694, 5,292,403, 5,246,549 and 4,18,4912 and EP-A-280445 and 464993.

Usually in deinking processes, the waste paper is formed into a pulp containing deinking chemicals. The pulp is normally subjected to one or more treatment stages, which may be an initial air flotation stage, optionally followed by a washing and/or thickening stage. The process water from the separation stage or any subsequent washing stage and/or thickening stage will normally be treated in a clarification stage. Ink and resinous particles are removed as a sludge. The clarified water may then be returned to the deinking process, for instance the pulper or alternatively may be used to dilute the treated cellulosic suspension prior to use in a paper or board making process.

Since the clarified process water will be usually returned to the pulping stage of the deinking process and/or used to dilute the pulp in the paper making process, if insufficient synthetic resinous particles are removed there is a risk that these will lead to a build up of sticky synthetic resinous particles in the deinking process where the clarified water is returned to the deinking process, with the inevitable increased likelihood that the treated pulp may contain unacceptable levels or the synthetic resinous particles are passed directly to the paper making process where the clarified water is used to dilute the treated pulp prior to paper making. In either situation the result would be that the hydrophobic resinous materials could adversely affect the paper making operation.

Although clarification of the process water will remove some of the synthetic hydrophobic sticky resinous particles, they are not always sufficiently effectivce and there remains an urgent need for a different and improved, cost effective, reproduceable method of controlling hydrophobic synthetic resinous particles in processes of recycling waste cellulosic material, such as deinking processes.

In a first aspect of the invention we provide a method of removing synthetic hydrophobic resinous particles from a waste treatment process in which an aqueous cellulosic suspension is formed from waste cellulosic material in a pulping stage,

passing the cellulosic suspension to a separation stage in which particles of ink and/or synthetic hydrophobic resinous materials are separated from the cellulosic suspension,

and optionally subjecting the cellulosic suspension to a washing stage and/or thickening stage,

to provide a treated pulp,

in which process water from the separation stage and/or washing and/or thickening stages is clarified in a clarification stage in which suspended solids, comprising synthetic hydrophobic resinous particles are removed,

and the clarified water is fed to the pulping stage in a clarification loop and/or combined with the treated pulp,

wherein a water soluble cationic polymer is added to the process water at or prior to the clarification stage,

characterised in that the water soluble cationic polymer formed from a monomer blend comprising,

a first water soluble cationic monomer selected from the group consisting of diallyl dialkyl ammonium halide, dialkylaminoalkyl (meth)acrylamide and dialkylaminoalkyl (meth)acrylate, including quaternary ammonium salts and acid addition salts thereof,

and a second water soluble cationic monomer comprising a hydrophobic moiety.

Typically the waste treatment process is a deinking process. In general a deinking process will involve first combining waste paper, water and deinking chemicals in a pulper to form a suspension of up to 18%. In the case of industrial processes involving high consistency pulping, the suspension may typically be 15 to 18%. Alternatively in other industrial scale deinking processes the suspension may be between 10 to 12% solids by weight. The deinking chemicals may be any of the commonly used chemical compounds or mixtures thereof. Often the deinking chemicals include any of alkalis, silicates, oxidizing compounds, soap alkaline earth metal salts and mixtures thereof.

In many deinking plants the cellulosic suspension is passed through a cleaning stage where extraneous heavy objects are removed from the suspension. The cellulsosic suspension is normally passed to a separation stage in which most but not necessarily all ink and resinous materials are separated from the cellulosic fibres. The separation stage may be a washing stage but generally the separation stage involves an air flotation treatment, wherein the suspension is passed to a flotation cell in which air bubbles are passed through the suspension in the cell and particles of ink and/or resinous materials are floated to the surface of the cell. The floated ink and/or resinous materials are separated to form a sludge, and process water contaminated with resinous solids and/or ink is passed to a clarification stage.

Following the separation stage the cellulosic suspension may be subjected to further treatment stages. For instance the cellulosic suspension may be treated further in a washing stage which removes residual ink and/or hydrophobic resinous particles from the cellulosic suspension. The cellulosic suspension may also be thickened in a thickening stage in order to increase the solids of the cellulosic suspension.

The treated cellulosic suspension from which ink and hydrophobic synthetic resinous materials have been removed may then be used for example in paper and board manufacture.

The process water from the separation stage or any subsequent washing stage and/or thickening stage will normally be treated in a clarification stage. Ink and resinous particles are removed as a sludge. The clarified water may then be returned to the deinking process, for instance the pulper or alternatively may be used to dilute the treated cellulosic suspension prior to use in a paper or board making process.

We have found that the removal of hydrophobic synthetic resinous particles is improved by application to the cellulosic suspension or water from the washing and/or thickening stages of a water soluble cationic polymer formed from a monomer blend comprising,

a first water soluble cationic monomer selected from the group consisting of diallyl dialkyl ammonium halide, dialkylaminoalkyl (meth)acrylamide and dialkylaminoalkyl (meth)acrylate, including quaternary ammonium salts and acid addition salts thereof,

and a second water soluble cationic monomer comprising a hydrophobic moiety.

The cationic polymer of the invention may be applied to the cellulosic suspension or water from the washing and/or thickening stage. Preferably the cationic polymer is added to the clarification stage. Optionally other flocculants and/or coagulants may also be used in the clarification process. Alternatively the cationic polymer may be to the water prior to the clarification stage. Typically other flocculants include a water soluble polymeric flocculants of intrinsic viscosity at least 3 dl/g.

Desirably the water soluble cationic polymer of the present invention is a copolymer in which the second cationic water soluble monomer contains aryl, alkaryl, aralkyl and alkyl containing at least 6 carbon atoms. Thus the copolymer would carry pendant groups selected from the group consisting of aryl, alkaryl, aralkyl and alkyl containing at least 6 carbon atoms. Preferably the water soluble second monomer is benzyl chloride quaternary ammonium salt of either dialkylaminoalkyl (meth)acrylate or dialkylaminoalkyl (meth)acrylamide.

The cationic polymer of the present invention is preferably derived from a first water soluble cationic monomer selected from the group consisting of diallyl dialkyl ammonium halide, dialkylaminoalkyl (meth)acrylamide and dialkylaminoalkyl (meth)acrylate, including quaternary ammonium salts and acid addition salts thereof.

The cationic polymer may be formed from the first and second monomers and optionally other suitable ethylenically unsaturated monomers. Generally where other monomers are present, they are present in an amount less than 10 to 15% by weight, more usually not more than 5% or 1 % by weight. Preferably the water soluble cationic polymer comprises 70 to 99% by weight of the first monomer and 1 to 30% by weight of the second monomer. More preferably the polymer comprises 75 to 95% by weight of the first monomer and 5 to 25% by weight of the second monomer. Most preferably the cationic polymer consists of the first and second cationic monomers.

In a particularly preferred for of the invention the first monomer is diallyldimethyl ammonium chloride and the second monomer is benzyl chloride quaternary ammonium salt of dialkylaminoalkyl (meth)acrylate.

The cationic polymer used in the present invention is desirably of relatively low molecular weight. For instance it has an intrinsic viscosity of below 3dl/g (measured using 1M NaCl buffered to pH 7 at 25° C.). Preferably the polymer has an intrinsic viscosity between 0.5 and 1.5 dl/g.

The cationic polymer will normally be applied to the process of the present invention in the form of an aqueous solution. The polymer may be prepared by aqueous solution polymerisation and then diluted to the appropriate strength for application. Preferably the polymer is formed as a solid polymer particles, for instance by suspension polymerisation and the aqueous polymer solution is formed by dissolving the polymer particles.

Typically the polymer is applied shortly before the clarification stage at a dose of between 10 and 40 ppm of suspended solids. Usually the dose is in the order of 20 to 30 ppm.

The second aspect of the invention relates to a novel polymer composition. Thus the invention relates to a water soluble cationic polymer formed from a monomer mixture comprising a first water soluble cationic monomer selected from the group consisting of diallyl dialkyl ammonium halide, dialkylaminoalkyl (meth)acrylamide and dialkylaminoalkyl (meth)acrylate, including quaternary ammonium salts and acid addition salts thereof and a second water soluble cationic monomer selected from benzyl chloride quaternary ammonium salt of either dialkylaminoalkyl (meth)acrylamide or dialkylaminoalkyl (meth)acrylate, characterised in that the polymer has an intrinsic viscosity of below 3dl/g and is in the form of solid particles.

Preferably the cationic polymer may be formed from the first and second monomers and optionally other suitable ethylenically unsaturated monomers. Generally where other monomers are present, they are present in an amount less than 10 to 15% by weight, more usually not more than 5% or 1% by weight. Preferably the water soluble cationic polymer comprises 70 to 99% by weight of the first monomer and 1 to 30% by weight of the second monomer. More preferably the polymer comprises 75 to 95% by weight of the first monomer and 5 to 25% by weight of the second monomer. Most preferably the cationic polymer consists of the first and second cationic monomers.

Most preferably the first monomer is diallyidimethyl ammonium chloride and the second monomer is benzyl chloride quaternary ammonium salt of dialkylaminoalkyl (meth)acrylate.

Desirably the polymer of the present invention is formed by suspension polymerisation of the first and second monomers. Thus an aqueous blend of first and second monomers is dispersed in a water immiscible liquid and polymerisation is effected employing suitable initiation techniques. The polymeric particles formed by this process will generally be in the form of beads.

The following examples illustrate the invention but should not be construed as limiting the scope thereof.

### EXAMPLE 1

180g of monomer solution consisting of 20:80 wt % ratio of the benzyl chloride quaternary ammonium salt of dimethyl aminoethyl acrylate (DMAEAqBzCl) and diallyldimethyl ammonium chloride (DADMAC) is prepared with a monomer concentration of 60%. 300 ppm of ethylenetriamine penta acetic acid and 2,000 ppm ammonium persulphate are each added to this monomer solution. The monomer pH was adjusted to 5.0.

In a reaction flask containing 300g of an oil phase (hydrocarbon solvent) and 3g of stabiliser, nitrogen is fed to deoxygenate the oil phase for a minimum of 30 minutes.

After degassing the nitrogen feed is removed and replaced with a condenser. The flask contents are then heated to about 75° C. at which point a vacuum is applied so that the oil phase gently refluxes (whilst the reaction flask contents are maintained at 75° C.). The reaction flask contents are under vacuum throughout the monomer feed, holding period and distillation. Throughout the polymerisation process agitation employing a heidolph+stirrer is maintained.

Once a steady a state has been established all the monomer is fed dropwise (at a steady rate) over a 30 minute period into the reaction flask, reaction temperature maintained between 70-75° C. After the ½ hr monomer feed the flask contents are maintained at about 75° C. for 1 hr. After the holding period the flask is heated to between 80-85° C. and the contents distilled to remove water present in the bead polymer. After distillation the flask contents are cooled and the bead polymer recovered, washed in acetone to remove residual solvent & stabiliser, filtered and then dried. The polymer has an intrinsic viscosity of 1.0 dl/g.

### EXAMPLE 2

A 70:30 newsprint:magazine furnish is placed in a laboratory disintigrator and pulper for 2000 counts at 4,5% consistency with the following additions:

sodium hydroxide 12.5% weight on fibre (w/f) (10%)

sodium silicate 4.16% w/f (42%)

Hydrogen peroxide 3.33% w/f (30%)

Serfax MT90 (soap) 1% w/f

Calcium Chloride 6-hydrate to 250 ppm water hardness (as CaCO₃)

The pulp is diluted to 1% consistency (with water adjusted to 250 ppm hardness (as CaCO₃)) and thickened to 10% via a 710 μm screen whilst collecting the backwater for clarification purposes.

By use of a laboratory flocculator, clarification studies are undertaken. The required dosage of polymer is added and stirred at 200 rpm for 30 seconds, settlement is allowed to occur and the turbidity of supernatant then measured.

The following polymers are produced by a solution polymerisation process to provide polymers of given aqueous concentration and molecular weight.

Monomers

DADMAC diallyldimethylammonium chloride

DMAEAqBzCl dmethylaminoethyl acrylate benzyl chloride quaternary ammonium salt

DMAEMAqBzCl dmethylaminoethyl meth acrylate benzyl chloride quaternary ammonium salt

Polymer A (comparative) homopolymer of DADMAC 40% concentration, average molecular weight 99,000.

Polymer B: 90:10 DADMAC:DMAEAqBzCl 60.3% concentration, average molecular weight 115,000.

Polymer C: 90:10 DADMAC:DMAEMAqBzCl 61.1% concentration, average molecular weight 104,000.

Polymer D: 80:20 DADMAC:DMAEAqBzCl 61.4% concentration, average molecular weight 99,000.

Polymer E: 80:20 DADMAC:DMAEAqBzCl 61.0% concentration, average molecular weight 91,000.

The turbidity results are shown in Table 1

TABLE 1

| Dosage | Polymer A | | | | |
|---|---|---|---|---|---|
| ppm | (comparative) | Polymer B | Polymer C | Polymer D | Polymer E |
| 10 | 531 | 559 | 464 | 1319 | 642 |
| 15 | 104 | 97 | 99 | 215 | 79 |
| 20 | 83 | 64 | 60 | 76 | 72 |
| 25 | 75 | 59 | 80 | 50 | 68 |
| 30 | 72 | 62 | | 44 | 60 |
| 35 | 95 | 85 | | 57 | 70 |

Turbidity Units are FAU

The blank turbidity is 3595 FAU.

The results show that polymers of the present invention, show improved performance over the comparative polymer.

### EXAMPLE 3

Example 2 is repeated except the chemical additions are added:

sodium hydroxide 12.5% w/f (10%)

sodium silicate 4.16% w/f (42%)

Hydrogen peroxide 3.33% w/f (30%)

Soep (ar) 1% w/f

Calcium Chloride 6-hydrate to 250 ppm water hardness (as CaCO₃)

Clarification studies are undertaken by adding the required dosage of polymer to 400 ml of inky washwater and stirring at 20 rpm for 30 seconds. The coagulants are then allowed to settle, the supernatent removed and assessment of turbidity by use of a Hach 2010 P spectrophotometer.

The test employs DADMAC copolymers with DMAEAB or DMAEMAB produced as polymer beads by the process described in Example 1. The following polymers are tested in this example:

Polymer F (comparative) homopolymer of DADMAC 40% concentration, intrinsic viscosity 0.3 dl/g.

Polymer G (comparative) homopolymer of DADMAC 40% concentration, intrinsic viscosity 1.3 dl/g.

Polymer H: 90:10 DADMAC:DMAEAqBzCl, intrinsic viscosity 1.5 dl/g.

Polymer l: 80:20 DADMAC:DMAEAqBzCl, intrinsic viscosity 1.1 dl/g.

The turbidity results are shown in table 2

TABLE 2

| Dosage | Polymer F | Polymer G | | |
|---|---|---|---|---|
| (ppm) | (comparative) | (comparative) | Polymer H | Polymer I |
| 0 | 848 | 848 | 848 | 848 |
| 1.25 | 150 | 124 | 109 | 102 |
| 2.5 | 83 | 66 | 57 | 54 |
| 3.75 | 80 | 54 | 40 | 36 |
| 5 | 79 | 38 | 30 | 26 |
| 6.25 | 74 | 43 | 37 | 48 |
| 7.5 | 80 | 53 | | |

Turbidity Units are FAU

The results clearly demonstrate that the cationic polymers, in form of solid particles of the present invention, outperform the known standard coagulants.

### EXAMPLE 4

Example 3 is repeated except using polymer J a 80:20 DADMAC:DMAEMAB copolymer prepared by aqueous solution polymerisation and polymer K a 80:20 DADMAC:DMAEMAqBzCl copolymer in the form of solid bead particles prepared according to the process described in example I and having an intrinsic viscosity of below 1.5dl/g.

The turbidity results are shown in table 3

TABLE 3

| Dosage | | |
|---|---|---|
| (ppm) | Polymer J | Polymer K |
| 0 | 2457 | 2457 |
| 2.5 | 150 | 106 |
| 5 | 60 | 44 |
| 7.5 | 45 | 36 |
| 10 | 41 | 39 |
| 12.5 | 45 | |

### EXAMPLE 5

Example 4 is repeated except using polymer L a 90:10 DADMAC:DMAEAqBzCl copolymer prepared by aqueous solution polymerisation and polymer M a 90:10 DADMAC:DMAEAqBzCl copolymer in the form of solid bead particles prepared according to the process described in example 1 and having an intrinsic viscosity of below 1.5 dl/g.

The turbidity results are shown in table 4

TABLE 4

| Dosage | | |
|---|---|---|
| (ppm) | Polymer L | Polymer M |
| 0 | 2457 | 2457 |
| 2.5 | 85 | 62 |
| 5 | 42 | 41 |
| 7.5 | 40 | 41 |
| 10 | 47 | 39 |
| 12.5 | | 44 |

The results of examples 3 and 4 show that although the polymers produced by solution polymerisation give good results, the polymers prepared as solid particles for the same co-monomer ratios by comparison give superior results.

1. A method of removing synthetic hydrophobic resinous particles from a waste treatment process in which an aqueous cellulosic suspension is formed from waste cellulosic material in a pulping stage,
passing the cellulosic suspension to a separation stage in which particles of ink and/or synthetic hydrophobic resinous materials are separated from the cellulosic suspension,
and optionally subjecting the cellulosic suspension to a washing stage and/or thickening stage,
to provide a treated pulp,
in which process water from the separation stage and/or washing and/or thickening stages is clarified in a clarification stage in which suspended solids,
comprising synthetic hydrophobic resinous particles are removed,
and the clarified water is fed to the pulping stage in a clarification loop and/or combined with the treated pulp,
wherein a water soluble cationic polymer is added to the process water at or prior to the clarification stage,
characterised in that the water soluble cationic polymer formed from a monomer blend comprising,
a first water soluble cationic monomer selected from the group consisting of diallyl dialkyl ammonium halide, dialkylaminoalkyl (meth)acrylamide and dialkylaminoalkyl (meth)acrylate, including quaternary ammonium salts and acid addition salts thereof,
and a second water soluble cationic monomer comprising a hydrophobic moiety.

2. A method according to claim 1 in which the waste treatment process is a deinking process.

3. A method according to claim 1 or claim 2 in which the aqueous cellulosic suspension is formed by combining the waste cellulosic material with water and treatment chemicals selected from the group consisting of alkalis, silicates, oxidizing compounds, soap alkaline earth metal salts and mixtures thereof.

4. A method according to any of claims 1 to 3 in which the separation stage comprises air flotation.

5. A method according to any of claims 1 to 4 in which hydrophobic synthetic resinous particles are removed from the water in the clarification stage.

6. A method according to any of claims 1 to 5 in which a water soluble polymeric flocculant of intrinsic viscosity at least 3 dl/g is added into the clarification stage.

7. A method according to any of claims 1 to 6 in which the hydrophobic moiety of the water soluble cationic polymer consists of pendant groups selected from aryl, alkaryl, aralkyl and alkyl containing at least 6 carbon atoms.

8. A method according to any of claims 1 to 7 in which the water soluble second monomer is benzyl chloride quaternary ammonium salt of either dialkylaminoalkyl (meth)acrylate or dialkylaminoalkyl (meth)acrylamide.

9. A method according to any of claims 1 to 8 in which the first water soluble cationic monomer selected from the group consisting of diallyl dialkyl ammonium halide, dialkylaminoalkyl (meth)acrylamide and dialkylaminoalkyl (meth)acrylate, including quaternary ammonium salts and acid addition salts thereof.

10. A method according to any of claims 1 to 9 in which the water soluble cationic polymer comprises 70 to 99% by weight of the first monomer and 1 to 30% by weight of the second monomer.

11. A method according to any one of claims 1 to 10 in which the first monomer is diallyldimethyl ammonium chloride and the second monomer is benzyl chloride quaternary ammonium salt of dialkylaminoalkyl-(meth)acrylate.

12. A method according to any of claims 1 to 11 in which the water soluble cationic polymer comprising a hydrophobic moiety has an intrinsic viscosity of below 3dl/g, preferably 0.5 to 1.5dl/g.

13. A method according to any of claims 1 to 12 in which the water soluble cationic polymer has been prepared in the form of solid particles.

14. A water soluble cationic polymer formed from a monomer mixture comprising a first water soluble cationic monomer selected from the group consisting of diallyl dialkyl ammonium halide, dialkylaminoalkyl (meth)acrylamide and dialkylaminoalkyl (meth)acrylate, including quaternary ammonium salts and acid addition salts thereof and a second water soluble cationic monomer selected from benzyl chloride quaternary ammonium salt of either dialkylaminoalkyl (meth)acrylamide or dialkylaminoalkyl (meth)acrylate,
characterised in that the polymer has an intrinsic viscosity of below 3dl/g and is in the form of solid particles.

15. A polymer according to claim 14 in which the first monomer is present in the monomer mixture in an amount selected from 70 to 99% by weight of total monomer and the second monomer is present in an amount of 1 to 30% by weight of total monomer.

16. A polymer according to claims 14 or claim 15 in which the first monomer is diallyldimethyl ammonium chloride and the second monomer is benzyl chloride quaternary ammonium salt of dialkylaminoalkyl (meth)acrylate.
